(19) United States
(12) Patent Application Publication
(10) Pub. No.: US 2020/0213570 A1
(43) Pub. Date: Jul. 2, 2020

(54) METHOD FOR PROCESSING PROJECTION-BASED FRAME THAT INCLUDES AT LEAST ONE PROJECTION FACE AND AT LEAST ONE PADDING REGION PACKED IN 360-DEGREE VIRTUAL REALITY PROJECTION LAYOUT

(71) Applicant: MEDIATEK INC., Hsin-Chu (TW)

(72) Inventors: Cheng-Hsuan Shih, Hsinchu City (TW); Ya-Hsuan Lee, Hsinchu City (TW); Jian-Liang Lin, Hsinchu City (TW)

(21) Appl. No.: 16/729,514

(22) Filed: Dec. 30, 2019

Related U.S. Application Data
(60) Provisional application No. 62/787,449, filed on Jan. 2, 2019.

(51) Int. Cl. H04N 13/139; H04N 19/597; H04N 19/132; H04N 19/167; H04N 19/186

(52) U.S. Cl. CPC H04N 13/139; H04N 19/597; H04N 9/3185; H04N 19/167; H04N 19/186; H04N 19/132

(57) ABSTRACT

A video processing method includes: receiving a part of a bitstream; decoding the part of the bitstream to generate a reconstructed projection-based frame with at least one projection face and at least one padding region packed in a projection layout of a 360-degree Virtual Reality (360 VR) projection; obtaining chroma sampling position information that is signaled via the bitstream; and performing a blending process for generating a blended chroma sample value at a target chroma sample position by blending a first chroma sample value obtained for a first chroma sample position in the at least one projection face and a second chroma sample value obtained for a second chroma sample position in the at least one padding region. At least one of the target chroma sample position, the first chroma sample position and the second chroma sample position is determined according to the chroma sampling position information.

### CROSS REFERENCE TO RELATED APPLICATIONS

This application claims the benefit of U.S. provisional application No. 62/787,449, filed on Jan. 2, 2019 and incorporated herein by reference.

### BACKGROUND

The present invention relates to processing omnidirectional image/video content, and more particularly, to a method for processing a projection-based frame that includes at least one projection face and at least one padding region packed in a 360-degree virtual reality (360 VR) projection layout.

Virtual reality (VR) with head-mounted displays (HMDs) is associated with a variety of applications. The ability to show wide field of view content to a user can be used to provide immersive visual experiences. A real-world environment has to be captured in all directions resulting in an omnidirectional image/video content corresponding to a sphere. With advances in camera rigs and HMDs, the delivery of VR content may soon become the bottleneck due to the high bitrate required for representing such 360-degree image/video contents. When the resolution of the omnidirectional video is 4K or higher, data compression/encoding is critical to bitrate reduction.

In general, the omnidirectional image/video content corresponding to the sphere is transformed into a sequence of images, each of which is a projection-based frame with a 360-degree image/video content represented by one or more projection faces arranged in a 360-degree Virtual Reality (360 VR) projection layout, and then the sequence of the projection-based frames is encoded into a bitstream for transmission. The projection-based frame may have image content discontinuity at layout boundaries and/or face edges. As a result, the image quality around layout boundaries and/or face edges after compression may be poor. Moreover, artifacts may be introduced by projection layout conversion of a reconstructed projection-based frame, thus leading to image quality degradation of a converted frame.

### SUMMARY

One of the objectives of the claimed invention is to provide a method for processing a projection-based frame that includes at least one projection face and at least one padding region packed in a 360-degree virtual reality (360 VR) projection layout.

According to a first aspect of the present invention, an exemplary video processing method is disclosed. The exemplary video processing method includes: receiving a part of a bitstream; decoding the part of the bitstream to generate a reconstructed projection-based frame with at least one projection face and at least one padding region packed in a projection layout of a 360-degree Virtual Reality (360 VR) projection; obtaining chroma sampling position information that is signaled via the bitstream; and performing a blending process for generating a blended chroma sample value at a target chroma sample position by blending a first chroma sample value obtained for a first chroma sample position in said at least one projection face of the reconstructed projection-based frame and a second chroma sample value obtained for a second chroma sample position in said at least one padding region of the reconstructed projection-based frame, wherein at least one of the target chroma sample position, the first chroma sample position and the second chroma sample position is determined according to the chroma sampling position information.

According to a second aspect of the present invention, an exemplary video processing method is disclosed. The exemplary video processing method includes: receiving a bitstream; decoding one part of the bitstream to generate a first reconstructed projection-based frame with at least one projection face and at least one padding region packed in a projection layout of a 360-degree Virtual Reality (360 VR) projection; performing a blending process upon the first reconstructed projection-based frame, comprising: generating a blended pixel value by blending a first pixel value obtained for a first pixel position in said at least one projection face of the first reconstructed projection-based frame and a second pixel value obtained for a second pixel position in said at least one padding region of the first reconstructed projection-based frame; and decoding another part of the bitstream to generate a second reconstructed projection-based frame, wherein the blended pixel value is used by inter prediction involved in generation of the second reconstructed projection-based frame.

According to a third aspect of the present invention, an exemplary video processing method is disclosed. The exemplary video processing method includes: receiving a bitstream; decoding one part of the bitstream to generate a first reconstructed projection-based frame with at least one projection face and at least one padding region packed in a projection layout of a 360-degree Virtual Reality (360 VR) projection; performing a blending process upon the first reconstructed projection-based frame, comprising: generating a blended pixel value by blending a first pixel value obtained for a first pixel position in said at least one projection face of the first reconstructed projection-based frame and a second pixel value obtained for a second pixel position in said at least one padding region of the first reconstructed projection-based frame; and decoding another part of the bitstream to generate a second reconstructed projection-based frame, wherein the first reconstructed projection-based frame acts as a reference frame used by inter prediction, and the blended pixel value is not used by inter prediction involved in generation of the second reconstructed projection-based frame.

According to a fourth aspect of the present invention, an exemplary video processing method is disclosed. The exemplary video processing method includes: receiving a part of a bitstream; decoding the part of the bitstream to generate a reconstructed projection-based frame with at least one projection face and at least one padding region packed in a projection layout of a 360-degree Virtual Reality (360 VR) projection; regarding a target pixel, finding a plurality of corresponding pixels in the reconstructed projection-based frame, wherein the target pixel and the corresponding pixels are mapped to a same point on a sphere, the corresponding pixels comprise a first pixel and a second pixel, the first pixel is located within said at least one projection face of the reconstructed projection-based frame, and the second pixel is located within said at least one padding region of the reconstructed projection-based frame; generating a blended pixel value by blending pixel values of the corresponding pixels; and setting a pixel value of the target pixel by the blended pixel value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a first 360-degree Virtual Reality (360 VR) system according to an embodiment of the present invention.

FIG. 2 is a diagram illustrating six square projection faces of a cubemap projection layout, obtained from cubemap projection of a sphere.

FIG. 3 is a diagram illustrating cubemap projection layouts with edge padding according to an embodiment of the present invention.

FIG. 4 is a diagram illustrating cubemap projection layouts with boundary padding and edge padding according to an embodiment of the present invention.

FIG. 5 is a diagram illustrating other cubemap projection layouts with boundary padding and edge padding according to an embodiment of the present invention.

FIG. 6 is a diagram illustrating an example of mapping from a pixel in a projection face to its corresponding padding pixel in a padding region.

FIG. 7 is a diagram illustrating an example of mapping from a padding pixel in a padding region to its corresponding pixel in a projection face.

FIG. 8 is a diagram illustrating a video decoding circuit with in-loop blending according to an embodiment of the present invention.

FIG. 9 is a diagram illustrating a video decoding circuit with out-loop blending according to an embodiment of the present invention.

FIG. 10 is a diagram illustrating a second 360 VR system according to an embodiment of the present invention.

FIG. 11 is a diagram illustrating an example of blending multiple corresponding pixels in a same source frame to derive a target pixel.

FIG. 12 is a diagram illustrating a third 360 VR system according to an embodiment of the present invention.

FIG. 13 is a diagram illustrating a 4:2:0 chroma format and four chroma sample location types.

FIG. 14 is a diagram illustrating an example of mapping from a chroma sample in a projection face to its corresponding chroma sample in a padding region.

FIG. 15 is a diagram illustrating an example of mapping from a chroma sample in a padding region to its corresponding chroma sample in a projection face.

FIG. 16 is a diagram illustrating an example of blending multiple corresponding chroma samples in a same source frame to derive a target chroma sample requested by a rendering process or a projection format conversion process.

FIG. 17 is a diagram illustrating an example of setting a chroma sampling position in a blending process by a chroma sampling position in a chroma format conversion process.

FIG. 18 is a diagram illustrating an example of setting a chroma sampling position in a blending process by a chroma sampling position in a projection format conversion process.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

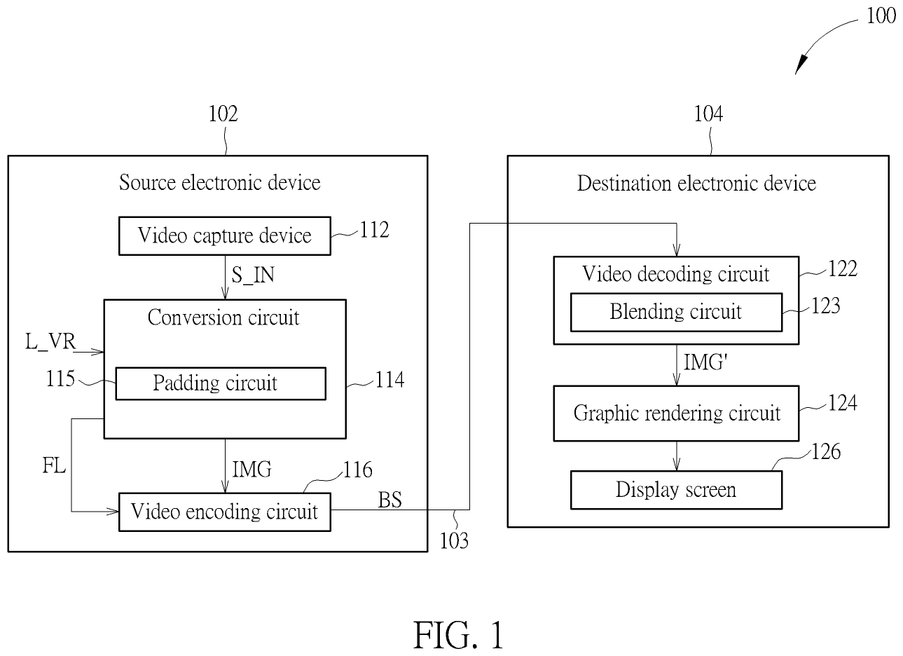

FIG. 1 is a diagram illustrating a first 360-degree Virtual Reality (360 VR) system according to an embodiment of the present invention. The 360 VR system 100 includes two video processing apparatuses (e.g., a source electronic device 102 and a destination electronic device 104). The source electronic device 102 includes a video capture device 112, a conversion circuit 114, and a video encoding circuit 116. For example, the video capture device 112 may be a set of cameras used to provide an omnidirectional image/video content (e.g., multiple images that cover the whole surroundings) S_IN corresponding to a sphere. The conversion circuit 114 is coupled between the video capture device 112 and the video encoding circuit 116. The conversion circuit 114 generates a projection-based frame IMG with a 360-degree Virtual Reality (360 VR) projection layout L_VR according to the omnidirectional image/video content S_IN. For example, the projection-based frame IMG may be one frame included in a sequence of projection-based frames generated from the conversion circuit 114.

In some embodiments of the present invention, the conversion circuit 114 may support chroma format conversion and projection format conversion. For example, the omnidirectional image/video content S_IN may be arranged in a source projection layout such as an equirectangular projection (ERP) layout, and the conversion circuit 114 may perform projection format conversion upon the omnidirectional image/video content S_IN to generate the projection-based frame IMG with the target 360 VR projection layout L_VR. For another example, each pixel of the omnidirectional image/video content S_IN may include chroma samples with a first chroma format (e.g., 4:4:4), and the conversion circuit 114 may perform chroma format conversion upon the omnidirectional image/video content S_IN, such that each pixel of an omnidirectional image/video content to be processed by projection format conversion may include chroma samples with a second chroma format (e.g., 4:2:0 or 4:2:2).

The video encoding circuit 116 is built on the basis of video encoder architecture, and is used to encode/compress the projection-based frame IMG to generate a part of a bitstream BS. Further, the video encoding circuit 116 outputs the bitstream BS to the destination electronic device 104 via a transmission means 103. For example, the sequence of projection-based frames may be encoded into the bitstream BS, and the transmission means 103 may be a wired/wireless communication link or a storage medium.

The destination electronic device 104 may be a head-mounted display (HMD) device. As shown in FIG. 1, the destination electronic device 104 includes a video decoding circuit 122, a graphic rendering circuit 124, and a display screen 126. The video decoding circuit 122 is built on the basis of video decoder architecture. Hence, the video decoding circuit 122 receives the bitstream BS from the transmission means 103 (e.g., wired/wireless communication link or storage medium), and performs a video decoder function for decoding a part of the received bitstream BS to generate a reconstructed projection-based frame (decoded frame) IMG′. For example, the video decoding circuit 122 generates a sequence of reconstructed frames by decoding different parts of the received bitstream BS, where the reconstructed projection-based frame IMG′ is one frame included in the sequence of reconstructed projection-based frames. In this embodiment, the projection-based frame IMG to be encoded by the video encoding circuit 116 at the encoder side has a 360 VR projection format with a projection layout. Hence, after the bitstream BS is decoded by the decoding circuit 122 at the decoder side, the reconstructed projection-based frame IMG′ is a reconstructed frame having the same 360 VR projection format and the same projection layout. The graphic rendering circuit 124 is coupled between the video decoding circuit 122 and the display screen 126. The graphic rendering circuit 124 renders and displays an output image data on the display screen 126 according to the reconstructed projection-based frame IMG′. For example, a viewport area associated with a portion of the 360-degree image/video content carried by the reconstructed projection-based frame IMG′ may be displayed on the display screen 126 via the graphic rendering circuit 124.

As mentioned above, the conversion circuit 114 generates the projection-based frame IMG according to the 360 VR projection layout L_VR and the omnidirectional image/video content S_IN. If the 360 VR projection layout L_VR is a compact projection layout without padding, it is possible that packing of projection faces may result in image content discontinuity edges between adjacent projection faces.

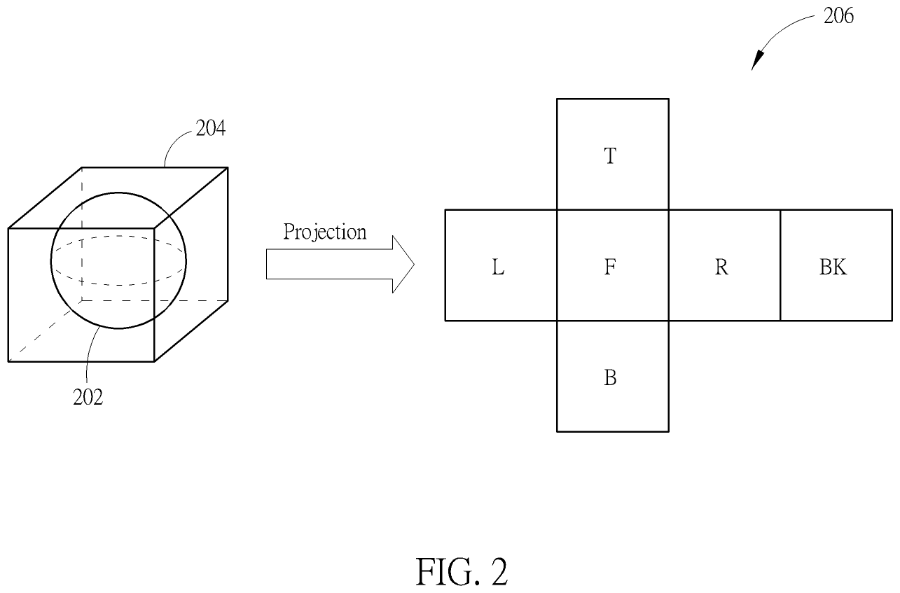

Consider a case where the 360 VR projection layout L_VR is set by a cubemap projection (CMP) layout without padding. Hence, the conversion circuit 114 obtains square projection faces from the omnidirectional image/video content S_IN of a sphere. That is, the omnidirectional image/video content of the sphere is mapped onto the square projection faces via cubemap projection. FIG. 2 is a diagram illustrating six square projection faces of a CMP layout, obtained from cubemap projection of a sphere. An omnidirectional image/video content of a sphere 202 is mapped onto six square projection faces (labeled by “L”, “F”, “R”, “BK”, “T”, and “B”) of a cube 204. The square projection face “L” means a left face of the cube 204. The square projection face “F” means a front face of the cube 204. The square projection face “R” means a right face of the cube 204. The square projection face “BK” means a back face of the cube 204. The square projection face “T” means a top face of the cube 204. The square projection face “B” means a bottom face of the cube 204. As shown in FIG. 2, the square projection faces “L”, “F”, “R”, “BK”, “T”, and “B” are arranged in a CMP layout 206 corresponding to an unfolded cube. The projection-based frame IMG to be encoded is required to be rectangular. If the CMP layout 206 is directly used for creating the projection-based frame IMG, the projection-based frame IMG has to be filled with dummy areas (e.g., black areas, gray areas, or white areas) to form a rectangular frame for encoding. Hence, the square projection faces “L”, “F”, “R”, “BK”, “T”, and “B” may be packed in another CMP layout without padding, such as a 1×6 cube layout, a 6×1 cube layout, a 3×2 cube layout, or a 2×3 cube layout. In this way, the coding efficiency can be improved. However, when the square projection faces “L”, “F”, “R”, “BK”, “T”, and “B” are packed in a compact CMP layout without padding, packing of projection faces results in image content discontinuity edges between adjacent projection faces, inevitably. Hence, if the 360 VR projection layout L_VR is set by the compact CMP layout without padding, the image quality near the image content discontinuity edges between projection faces after compression may be poor, and the image quality near the layout boundaries (which may also be regarded as image content discontinuity edges) after compression may be poor. Specifically, when square projection faces are packed in a CMP layout without padding such as a 1×6 cube layout, a 6×1 cube layout, a 3×2 cube layout, or a 2×3 cube layout, the projection-based frame IMG after coding may have artifacts due to discontinuous layout boundaries of the CMP layout and/or discontinuous edges of the CMP layout. For example, the CMP layout without padding has a top discontinuous boundary, a bottom discontinuous boundary, a left discontinuous boundary, and a right discontinuous boundary. In addition, there is at least one image content discontinuous edge between two adjacent square projection faces packed in the CMP layout without padding.

To address the above issue, the conversion circuit 114 is equipped with a padding circuit 115 for generating padding region(s), and is arranged to employ the 360 VR projection layout L_VR that is set by a projection layout with padding. Around layout boundaries and/or discontinuous edges, additional padding regions generated by pixel padding can be inserted for reducing the seam artifacts.

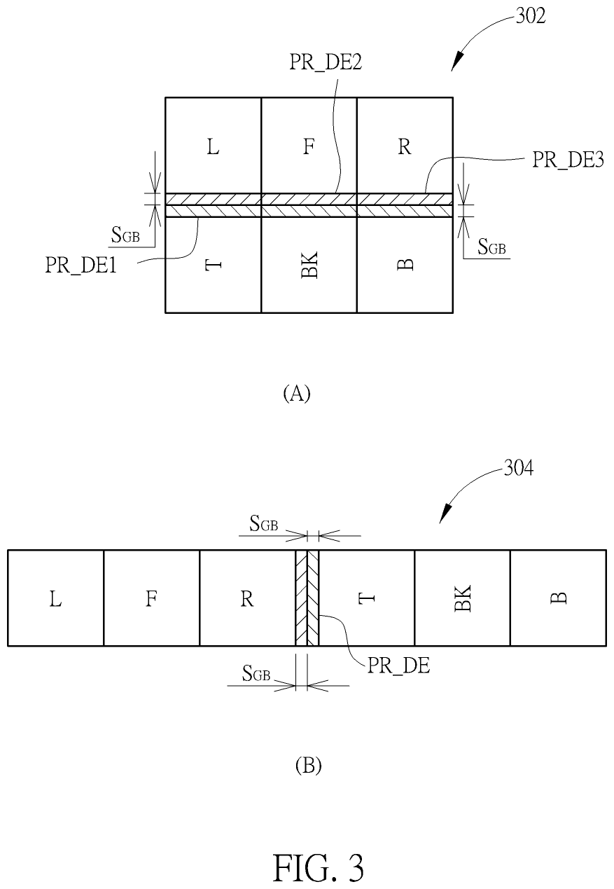

For example, pixel padding can be only added at discontinuous edges. FIG. 3 is a diagram illustrating cubemap projection layouts with edge padding according to an embodiment of the present invention. The sub-diagram (A) of FIG. 3 illustrates a 3×2 cube layout with edge padding 302. An image content discontinuity edge exists between the square projection faces “L” and “T” if the bottom side of the square projection face “L” connects with the top side of the square projection face “T” in a typical 3×2 cube projection layout without padding. An image content discontinuity edge exists between the square projection faces “F” and “BK” if the bottom side of the square projection face “F” connects with the top side of the square projection face “BK” in a typical 3×2 cube projection layout without padding. An image content discontinuity edge exists between the square projection faces “R” and “B” if the bottom side of the square projection face “R” connects with the top side of the square projection face “B” in a typical 3×2 cube projection layout without padding. In accordance with the 3×2 cube projection layout with padding 302, a padding region PR_DE1 is inserted between the square projection faces “L” and “T”, a padding region PR_DE2 is inserted between the square projection faces “F” and “BK”, and a padding region PR_DE3 is inserted between the square projection faces “R” and “B”.

The first padding region PR_DE1 includes padding pixels extended from the square projection face “L” and padding pixels extended from the square projection face “T”, and therefore isolates the bottom side of the square projection face “L” from the top side of the square projection face “T” in the projection layout 302. The second padding region PR_DE2 includes padding pixels extended from the square projection face “F” and padding pixels extended from the square projection face “BK”, and therefore isolates the bottom side of the square projection face “F” from the top side of the square projection face “BK” in the projection layout 302. The third padding region PR_DE3 includes padding pixels extended from of the square projection face “R” and padding pixels extended from of the square projection face “B”, and therefore isolates the bottom side of the square projection face “R” from the top side of the square projection face “B” in the projection layout 302. The pixel padding size for one square projection face is S_{GB}. Hence, the width of each padding region PR_DE1/PR_DE2/PR_DE3 is equal to 2*S_{GB}.

The sub-diagram (B) of FIG. 3 illustrates a 6×1 cube layout with edge padding 304. An image content discontinuity edge exists between the square projection faces “R” and “T” if the right side of the square projection face “R” connects with the left side of the square projection face “T” in a typical 6×1 cube projection layout without padding. In accordance with the 6×1 cube projection layout with padding 304, a padding region PR_DE is inserted between the square projection faces “R” and “T”. The padding region PR_DE includes padding pixels extended from the square projection face “R” and padding pixels extended from the square projection face “T”, and therefore isolates the right side of the square projection face “R” from the left side of the square projection face “T” in the projection layout 304. The pixel padding size for one square projection face is S_{GB}. Hence, the width of the padding region PR_DE is equal to 2*S_{GB}.

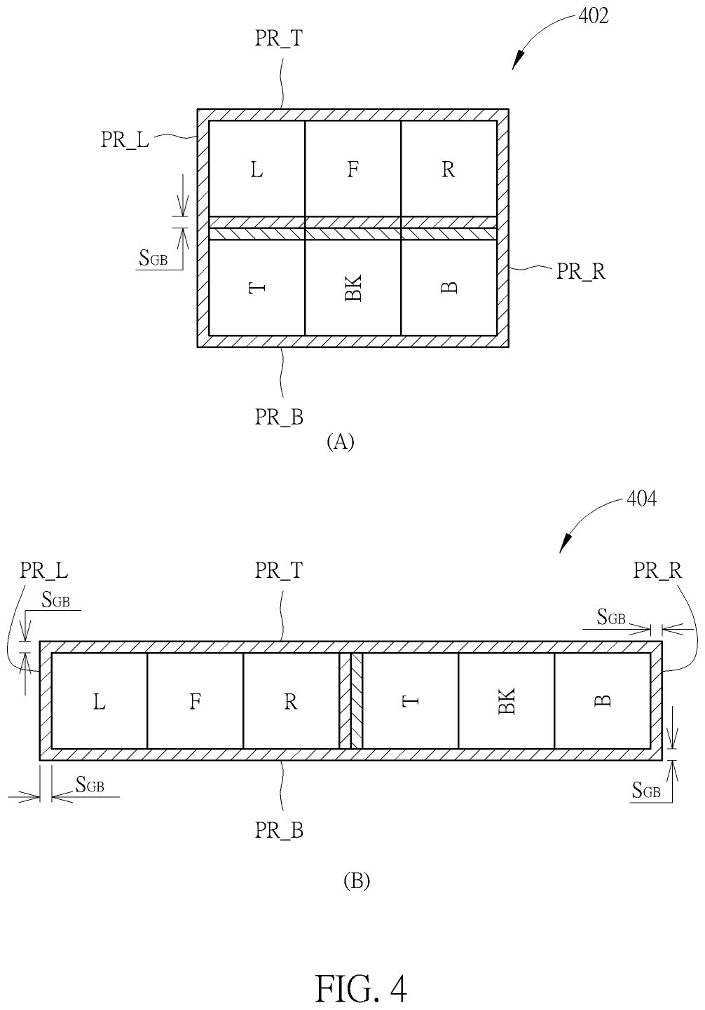

For another example, padding can be added at layout boundaries and discontinuous edges. FIG. 4 is a diagram illustrating cubemap projection layouts with boundary padding and edge padding according to an embodiment of the present invention. The sub-diagram (A) of FIG. 4 illustrates a 3×2 cube layout with boundary padding and edge padding 402. If the square projection faces are packed in a typical 3×2 cube projection layout without padding, top sides of the square projection faces “L”, “F”, and “R” forma top discontinuous boundary, bottom sides of the square projection faces “T”, “BK”, and “B” form a bottom discontinuous boundary, left sides of the square projection faces “L” and “T” form a left discontinuous boundary, and right sides of the square projection faces “R” and “B” form a right discontinuous boundary. The 3×2 cube layout with boundary padding and edge padding 402 can be derived from adding boundary padding to the 3×2 cube layout with edge padding 302. Hence, in addition to the padding regions PR_DE1, PR_DE2, PR_DE3 at discontinuous edges, the 3×2 cube layout with boundary padding and edge padding 402 further has a top padding region PR_T that connects with top sides of the square projection faces “L”, “F”, and “R”, a bottom padding region PR_B that connects with bottom sides of the square projection faces “T”, “BK”, and “B”, a left padding region PR_L that connects with left sides of the square projection faces “L” and “T”, and a right padding region PR_R that connects with right sides of the square projection faces “R” and “B”.

The top padding region PR_T includes padding pixels extended from the square projection faces “L”, “F”, and “R”. The bottom padding region PR_B includes padding pixels extended from the square projection faces “T”, “BK”, and “B”. The left padding region PR_L includes padding pixels extended from the square projection faces “L” and “T”. The right padding region PR_R includes padding pixels extended from the square projection faces “R” and “B”. The pixel padding size for one square projection face is S_{GB}. Hence, the width of each boundary padding region PR_T/PR_B/PR_L/PR_R is equal to S_{GB}.

The sub-diagram (B) of FIG. 4 illustrates a 6×1 cube layout with boundary padding and edge padding 404. If the square projection faces are packed in a typical 6×1 cube projection layout without padding, top sides of the square projection faces “L”, “F”, “R”, “T”, “BK”, and “B” form a top discontinuous boundary, bottom sides of the square projection faces “L”, “F”, “R”, “T”, “BK”, and “B” forma bottom discontinuous boundary, a left side of the square projection face “L” forms a left discontinuous boundary, and a right side of the square projection face “B” forms a right discontinuous boundary. The 6×1 cube layout with boundary padding and edge padding 404 can be derived from adding boundary padding to the 6×1 cube layout with edge padding 304. Hence, in addition to the padding region PR_DE at the discontinuous edge, the 6×1 cube layout with boundary padding and edge padding 404 further has a top padding region PR_T that connects with top sides of the square projection faces “L”, “F”, “R”, “T”, “BK”, and “B”, a bottom padding region PR_B that connects with bottom sides of the square projection faces “L”, “F”, “R”, “T”, “BK”, and “B”, a left padding region PR_L that connects with the left side of the square projection face “L”, and a right padding region PR_R that connects with the right side of the square projection face “B”.

The top padding region PR_T includes padding pixels extended from the square projection faces “L”, “F”, “R”, “T”, “BK”, and “B”. The bottom padding region PR_B includes padding pixels extended from the square projection faces “L”, “F”, “R”, “T”, “BK”, and “B”. The left padding region PR_L includes padding pixels extended from the square projection face “L”. The right padding region PR_R includes padding pixels extended from the square projection face “B”. The pixel padding size for one square projection face is S_{GB}. Hence, the width of each boundary padding region PR_T/PR_B/PR_L/PR_R is equal to S_{GB}.

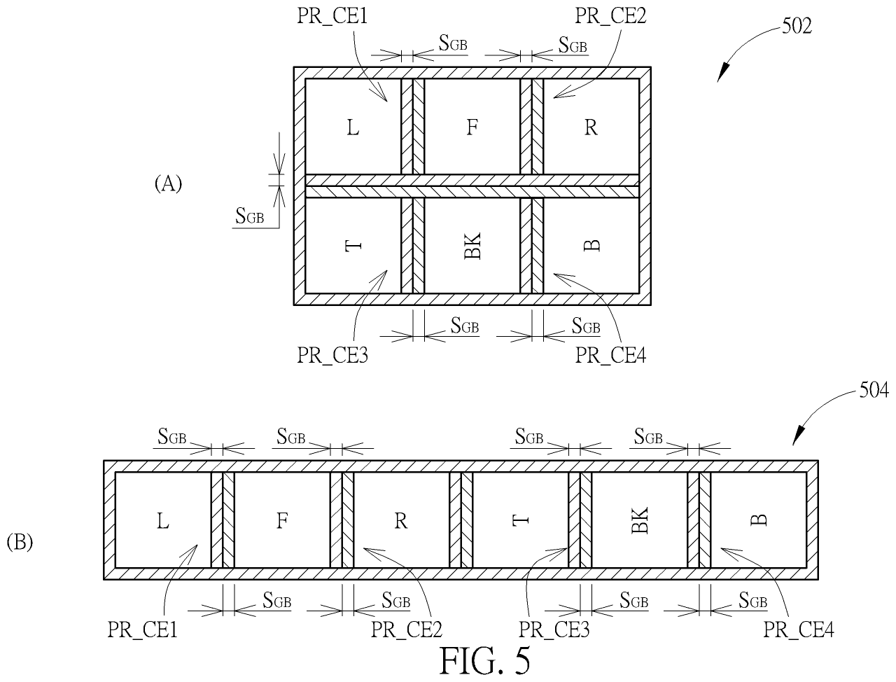

For yet another example, padding can be added at layout boundaries, discontinuous edges, and continuous edges. FIG. 5 is a diagram illustrating other cubemap projection layouts with boundary padding and edge padding according to an embodiment of the present invention. The sub-diagram (A) of FIG. 5 illustrates another 3×2 cube layout with boundary padding and edge padding 502. An image content continuity edge exists between the square projection faces “L” and “F” if the right side of the square projection face “L” connects with the left side of the square projection face “F” in a typical 3×2 cube projection layout without padding. An image content continuity edge exists between the square projection faces “F” and “R” if the right side of the square projection face “F” connects with the left side of the square projection face “R” in a typical 3×2 cube projection layout without padding. An image content continuity edge exists between the square projection faces “T” and “BK” if the right side of the square projection face “T” connects with the left side of the square projection face “BK” in a typical 3×2 cube projection layout without padding. An image content continuity edge exists between the square projection faces “BK” and “B” if the right side of the square projection face “BK” connects with the left side of the square projection face “B” in a typical 3×2 cube projection layout without padding.

The 3×2 cube layout with boundary padding and edge padding 502 can be derived from adding more padding to the 3×2 cube layout with boundary padding and edge padding 402. Hence, in addition to the padding regions PR_DE1, PR_DE2, PR_DE3 at discontinuous edges and padding regions PR_T, PR_B, PR_L, PR_R at discontinuous boundaries, the 3×2 cube layout with boundary padding and edge padding 502 further has a padding region PR_CE1 that connects with the right side of the square projection face “L” and the left side of the square projection face “F”, a padding region PR_CE2 that connects with the right side of the square projection face “F” and the left side of the square projection face “R”, a padding region PR_CE3 that connects with the right side of the square projection face “T” and the left side of the square projection face “BK”, and a padding region PR_CE4 that connects with the right side of the square projection face “BK” and the left side of the square projection face “B”.

The padding region PR_CE1 includes padding pixels extended from the square projection faces “L” and “F”, and therefore isolates the right side of the square projection face “L” from the left side of the square projection face “F” in the projection layout 502. The padding region PR_CE2 includes padding pixels extended from the square projection faces “F” and “R”, and therefore isolates the right side of the square projection face “F” from the left side of the square projection face “R” in the projection layout 502. The padding region PR_CE3 includes padding pixels extended from the square projection faces “T” and “BK”, and therefore isolates the right side of the square projection face “T” from the left side of the square projection face “BK” in the projection layout 502. The padding region PR_CE4 includes padding pixels extended from the square projection faces “BK” and “B”, and therefore isolates the right side of the square projection face “BK” from the left side of the square projection face “B” in the projection layout 502. The pixel padding size for one square projection face is S_{GB}. Hence, the width of each padding region PR_CE1/PR_CE2/PR_CE3/PR_CE4 is equal to 2*S_{GB}.

The sub-diagram (B) of FIG. 5 illustrates another proposed 6×1 cube layout with boundary padding and edge padding 504. The 6×1 cube layout with boundary padding and edge padding 504 can be derived from adding more padding to the 6×1 cube layout with boundary padding and edge padding 404. Hence, in addition to the padding region PR_DE at the discontinuous edge and padding regions PR_T, PR_B, PR_L, PR_R at the discontinuous boundaries, the 6×1 cube layout with boundary padding and edge padding 504 further has four padding regions PR_CE1, PR_CE2, PR_CE3, and PR_CE4. The pixel padding size for one square projection face is S_{GB}. Hence, the width of each padding region PR_CE1/PR_CE2/PR_CE3/PR_CE4 is equal to 2*S_{GB}.

It should be noted that the aforementioned CMP layouts with padding are for illustrative purposes only, and are not meant to be limitations of the present invention. The same padding concept may be applied to other projection layouts. That is, a 360 VR projection layout with padding may be obtained by adding padding region(s) to a layout of other projection format, such as an equirectangular projection (ERP) layout, a pyramid projection layout, a truncated square pyramid (TSP) projection layout, a sphere segmented projection (SSP) layout, a tetrahedron projection layout, a tetragon quartz-based projection layout, an icosahedron projection layout, or a hexagon quartz-based projection layout. To put it simply, the 360 VR projection layout L_VR may be set by any projection layout with padding.

In a first exemplary padding design, the padding circuit 115 applies geometry padding to a projection face to determine pixel values of pixels included in a padding region that connects with the projection face. The content of a region on a sphere is mapped onto the padding region, where the region on the sphere is adjacent to a region from which the projection face is obtained.

In a second exemplary padding design, the padding circuit 115 sets pixel values of pixels included in a padding region connected to one side of a projection face by duplicating pixel values of pixels included in a different projection face that does not connect with the padding region, or by duplicating pixel values of pixels located at an opposite side of the same projection face.

In a third exemplary padding design, the padding circuit 115 sets pixel values of pixels included in a padding region by duplicating pixel values of edge pixels included in a projection face that connects with the padding region.

As mentioned above, the video decoding circuit 122 of the destination electronic device 104 receives the bitstream BS from the transmission means 103 (e.g., wired/wireless communication link or storage medium), and performs a video decoder function for decoding a part of the received bitstream BS to generate the reconstructed projection-based frame IMG′ that is a reconstructed frame having the same 360 VR projection layout L_VR employed by the conversion circuit 114 of the source electronic device 102. In a case where the 360 VR projection layout L_VR is set by a projection layout with padding (e.g., a projection layout with boundary padding, a projection layout with edge padding, or a projection layout with boundary padding and edge padding), the reconstructed projection-based frame IMG′ has padding regions located at layout boundaries and/or face edges of a projection layout. In one embodiment, the video decoding circuit 122 may crop the padding regions, such that only the non-padding regions (e.g., omnidirectional image/video content represented in projection face(s) originally obtained from 360 VR projection) are reconstructed. In an alternative design, the video decoding circuit 122 may enable a blending circuit 123 for performing blending that is based on padding pixels in a padding region and pixels in a non-padding region.

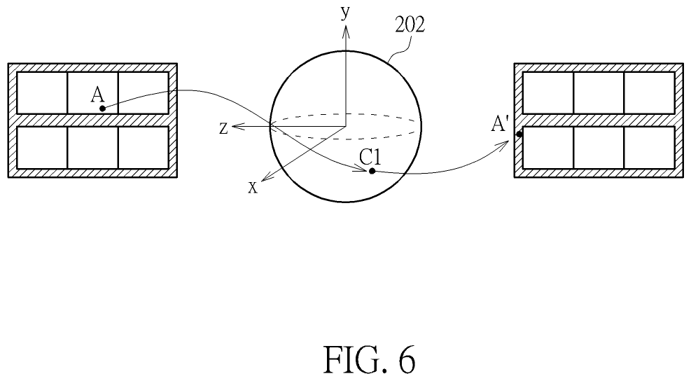

For example, a pixel value of a pixel in a projection face may be updated by blending an original pixel value of the pixel in the projection face with a pixel value of a corresponding padding pixel in a padding region. If geometry mapping is used by the padding circuit 115 for generating padding pixels, a mapping from a pixel in a projection face to its corresponding padding pixel in a padding region is required. FIG. 6 is a diagram illustrating an example of mapping from a pixel in a projection face to its corresponding padding pixel in a padding region. Suppose that the 360 VR projection layout L_VR is set by the 3×2 cube layout with boundary padding and edge padding 402 as shown in sub-diagram (A) of FIG. 4. One pixel A in a projection face is first mapped to a 3D point C1 on the sphere 202. Next, the 3D point C1 on the sphere 202 is mapped to a padding pixel A′ in a padding region through cube-based projection. A pixel value of the pixel A and a pixel value of the padding pixel A′ may be blended by, for example, a distance-based weighting function to generate a blended pixel value that is used to update the original pixel value of the pixel A.

If a padding region of a projection face is obtained by applying geometry padding to the projection face according to the aforementioned first exemplary padding design, the padding pixel A′ may be located at a non-integer position (i.e., (x, y), where x is not an integer position, and/or y is not an integer position) in the padding region. Specifically, the 2D coordinate of the padding pixel A′ is converted from the 2D coordinate of the pixel A due to geometry mapping. That is, the pixel A located at an integer position (i.e., (X, Y), where X and Y are integer positions) in the projection face may be mapped to the padding pixel A′ located at a non-integer position (i.e., (x, y), where x is not an integer position, and/or y is not an integer position) in the padding region. Since a pixel value of the padding pixel A′ located at a non-integer position is not directly available in the padding region, the blending circuit 123 may determine the pixel value of the padding pixel A′ located at the non-integer position in the padding region by using an interpolation filter (not shown) to process neighboring padding pixels located at integer positions.

For certain applications, a conversion circuit may be implemented in a destination electronic device to convert a reconstructed frame with a projection layout of a first 360 VR projection format into a converted frame with a projection layout of a second 360 VR projection format that is different from the first 360 VR projection format. For example, the reconstructed frame generated from a decoding circuit may be a projection-based frame with projection faces and padding regions packed in a cubemap projection layout with padding, and the converted frame generated from the conversion circuit and used by a following graphic rendering circuit may be a projection-based frame with projection faces packed in a typical equirectangular projection (ERP) layout without padding. A pixel located at an integer position (i.e., (x, y), where x and y are integer positions) in the converted frame may be mapped to a pixel located at a non-integer position (i.e., (x′, y′), where x′ is not an integer position and/or y′ is not an integer position) in the reconstructed frame. That is, when performing projection layout conversion, the conversion circuit may set a pixel value of a pixel located at an integer position in the converted frame by a pixel value of a pixel located at a non-integer position in the reconstructed frame. Since a pixel value of a pixel located at a non-integer position is not directly available in the decoded frame, the conversion circuit may determine the pixel value of the pixel located at the non-integer position in the reconstructed frame by using an interpolation filter to process pixels located at integer positions in the reconstructed frame. In a case where the pixel with the non-integer position is at or near an edge of a projection face in the reconstructed frame, the pixels used by the interpolation filter may include at least one pixel selected from the projection face and at least one pixel selected from the corresponding padding region. As mentioned above, pixel values of pixels in the projection face are updated by blending (e.g., distance-based weighting). However, if pixel values of padding pixels in the corresponding padding region are not updated by blending (e.g., distance-based weighting), artifacts may be introduced due to interpolation performed upon updated pixel values of pixels in the projection face and original pixel values of padding pixels in the corresponding padding region. To address this issue, blending may be performed to update pixel values of pixels in a projection face as well as pixel values of padding pixels in a corresponding padding region.

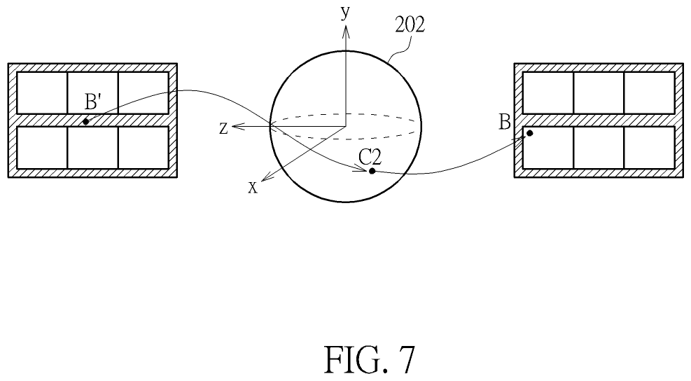

A pixel value of a padding pixel in a padding region may be updated by blending an original pixel value of the padding pixel in the padding region and a pixel value of a corresponding pixel in a projection face. If geometry mapping is used by the padding circuit 115 for generating padding pixels, a mapping from a padding pixel in a padding region to its corresponding pixel in a projection face is required. FIG. 7 is a diagram illustrating an example of mapping from a padding pixel in a padding region to its corresponding pixel in a projection face. Suppose that the 360 VR projection layout L_VR is set by the 3×2 cube layout with boundary padding and edge padding 402 as shown in sub-diagram (A) of FIG. 4. One padding pixel B′ in a padding region is first mapped to a 3D point C2 on the sphere 202. Next, the 3D point C2 on the sphere 202 is mapped to a pixel B in a projection face through cube-based projection. A pixel value of the pixel B and a pixel value of the padding pixel B′ may be blended by, for example, a distance-based weighting function to generate a blended pixel value that is used to update the original pixel value of the padding pixel B′.

If a padding region of a projection face is obtained by applying geometry padding to the projection face according to the aforementioned first exemplary padding design, the pixel B may be located at a non-integer position (i.e., (X, Y), where X is not an integer position, and/or Y is not an integer position) in the projection face. Specifically, the 2D coordinate of the pixel B is converted from the 2D coordinate of the padding pixel B′ due to geometry mapping. That is, the padding pixel B′ located at an integer position (i.e., (x, y), where x and y are integer positions) in the padding region may be mapped to the pixel B located at a non-integer position (i.e., (X, Y), where X is not an integer position, and/or Y is not an integer position) in the projection region. Since a pixel value of the pixel B located at a non-integer position is not directly available in the projection face, the blending circuit 123 may determine the pixel value of the pixel B located at the non-integer position in the projection face by using an interpolation filter (not shown) to process neighboring pixels located at integer positions.

In the embodiment shown in FIG. 1, the blending circuit 123 is a part of the video decoding circuit 122. The blending process performed by the blending circuit 123 maybe in a way of in-loop or out-loop, depending upon the actual design considerations.

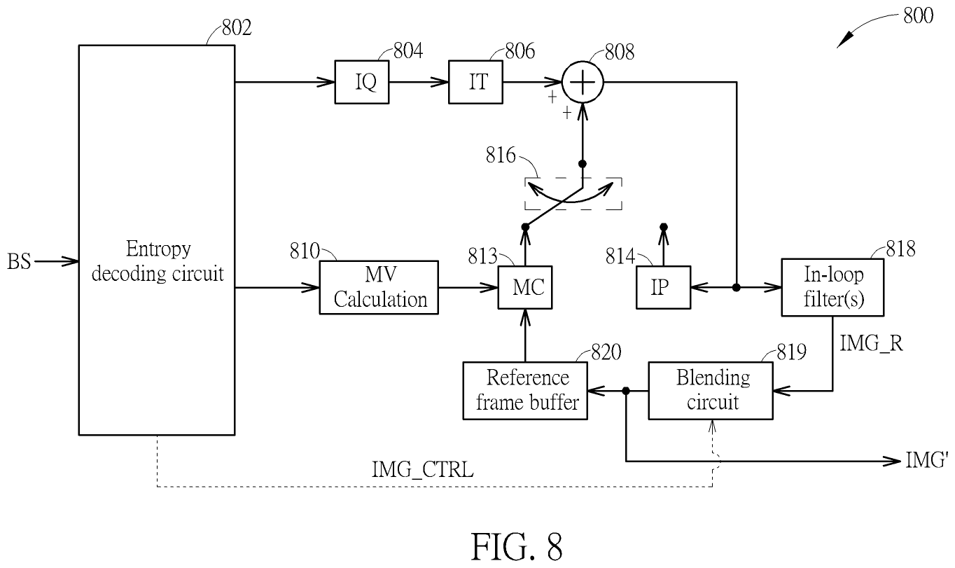

FIG. 8 is a diagram illustrating a video decoding circuit with in-loop blending according to an embodiment of the present invention. The video decoding circuit 122 shown in FIG. 1 may be implemented using the video decoding circuit 800 shown in FIG. 8. In this embodiment, the video decoding circuit 800 is arranged to receive the bitstream BS as an input bitstream and decode one part of the received bitstream BS to generate the reconstructed projection-based frame (decoded frame) IMG′ that is supplied to a following stage (e.g., graphic rendering circuit 124 shown in FIG. 1). It should be noted that the video decoder architecture shown in FIG. 8 is for illustrative purposes only, and is not meant to be a limitation of the present invention. As shown in FIG. 8, the video decoding circuit 800 includes an entropy decoding circuit (e.g., a variable length decoder) 802, an inverse quantization circuit (denoted by “IQ”) 804, an inverse transform circuit (denoted by “IT”) 806, a reconstruction circuit 808, a motion vector calculation circuit (denoted by “MV Calculation”) 810, a motion compensation circuit (denoted by “MC”) 813, an intra prediction circuit (denoted by “IP”) 814, an intra/inter mode selection switch 816, at least one in-loop filter 818, a blending circuit 819, and a reference frame buffer 820. The blending circuit 123 shown in FIG. 1 may be implemented by the in-loop blending circuit 819 shown in FIG. 8.

When a block is inter-coded, the motion vector calculation circuit 810 refers to information parsed from the bitstream BS by the entropy decoding circuit 802 to determine a motion vector between a current block of the frame being decoded and a predicted block of a reference frame that is a reconstructed frame and stored in the reference frame buffer 820. The motion compensation circuit 813 may perform interpolation filtering to generate the predicted block according to the motion vector. The predicted block is supplied to the intra/inter mode selection switch 816. Since the block is inter-coded, the intra/inter mode selection switch 816 outputs the predicted block generated from the motion compensation circuit 813 to the reconstruction circuit 808. When a block is intra-coded, the intra prediction circuit 814 generates the predicted block to the intra/inter mode selection switch 816. Since the block is intra-coded, the intra/inter mode selection switch 816 outputs the predicted block generated from the intra prediction circuit 814 to the reconstruction circuit 808.

In addition, decoded residual of the block is obtained through the entropy decoding circuit 802, the inverse quantization circuit 804, and the inverse transform circuit 806. The reconstruction circuit 808 combines the decoded residual and the predicted block to generate a reconstructed block. The reconstructed block may be stored into the reference frame buffer 820 to be a part of a reference frame (which is a reconstructed frame) that may be used for decoding following blocks. Particularly, each reference frame stored in the reference frame buffer 820 can be used by inter prediction. Before the reconstructed block is stored into the reference frame buffer 820, the in-loop filter(s) 818 may perform designated in-loop filtering upon the reconstructed block. For example, the in-loop filter(s) 818 may include a de-blocking filter. Furthermore, before the reconstructed block is stored into the reference frame buffer 820, the blending circuit 819 performs designated blending upon the reconstructed block. Specifically, the blending circuit 819 performs a blending process upon a first reconstructed projection-based frame IMG_R (which is an output of in-loop filter(s) 818), and store a blended reference frame into the reference frame buffer 820, where an output of the blending circuit 819 also acts as the reconstructed projection-based frame (decoded frame) IMG′ that is supplied to the following stage (e.g., graphic rendering circuit 124 shown in FIG. 1). The blended reference frame includes a blended pixel value that is generated by blending a first pixel value obtained for a first pixel position in one projection face of the reconstructed projection-based frame IMG_R and a second pixel value obtained for a second pixel position in one padding region of the reconstructed projection-based frame IMG_R. When the video decoding circuit 800 is decoding another part of the bitstream BS to generate a second reconstructed projection-based frame (which is an output of the in-loop filter(s) 818), the blended reference frame (which is derived from the first reconstructed projection-based frame IMG_R) is used by inter prediction, such that the blended pixel value is used by inter prediction involved in generation of the second reconstructed projection-based frame. The blending circuit 819 may be controlled by control information INF_CTRL parsed from the bitstream BS. For example, the control information INF_CTRL may include a flag indicative of chroma sampling position information.

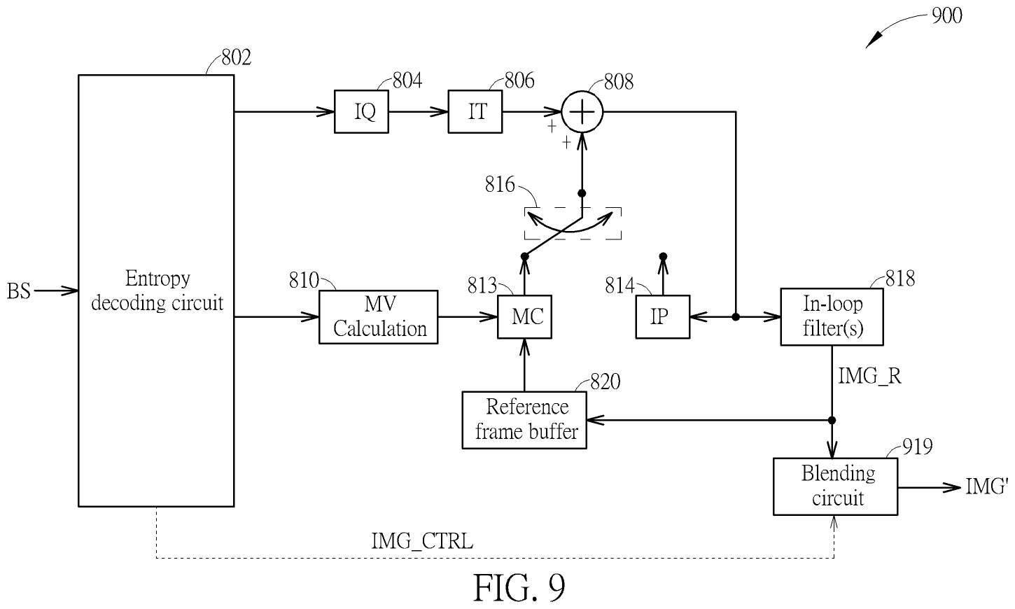

FIG. 9 is a diagram illustrating a video decoding circuit with out-loop blending according to an embodiment of the present invention. The video decoding circuit 122 shown in FIG. 1 may be implemented using the video decoding circuit 900 shown in FIG. 9. In this embodiment, the video decoding circuit 900 is arranged to receive the bitstream BS as an input bitstream and decode one part of the received bitstream BS to generate the reconstructed projection-based frame (decoded frame) IMG′ that is supplied to a following stage (e.g., graphic rendering circuit 124 shown in FIG. 1). It should be noted that the video decoder architecture shown in FIG. 9 is for illustrative purposes only, and is not meant to be a limitation of the present invention. The major difference between the video decoding circuits 800 and 900 is that the video decoding circuit 900 has a blending circuit 919 that does not store its output into the reference frame buffer 820. The blending circuit 123 shown in FIG. 1 may be implemented by the out-loop blending circuit 919 shown in FIG. 9.

The reconstruction circuit 808 combines the decoded residual and the predicted block to generate a reconstructed block. The reconstructed block may be stored into the reference frame buffer 820 to be apart of a reference frame (which is a reconstructed frame) that may be used for decoding following blocks. Particularly, each reference frame stored in the reference frame buffer 820 can be used by inter prediction. Before the reconstructed block is stored into the reference frame buffer 820, the in-loop filter(s) 818 may perform designated in-loop filtering upon the reconstructed block. For example, the in-loop filter(s) 818 may include a de-blocking filter. The blending circuit 919 performs designated blending upon the reconstructed block. Specifically, the blending circuit 919 performs a blending process upon a first reconstructed projection-based frame IMG_R (which is an output of the in-loop filter(s) 818), and generate the reconstructed projection-based frame (decoded frame) IMG′ that is supplied to the following stage (e.g., graphic rendering circuit 124 shown in FIG. 1). The reconstructed projection-based frame IMG′ is a blended frame including a blended pixel value that is generated by blending a first pixel value obtained for a first pixel position in one projection face of the first reconstructed projection-based frame IMG_R and a second pixel value obtained for a second pixel position in one padding region of the first reconstructed projection-based frame IMG_R. When the video decoding circuit 900 is decoding another part of the bitstream BS to generate a second reconstructed projection-based frame (which is an output of the in-loop filter(s) 818), the first reconstructed projection-based frame IMG_R is a reference frame stored into the reference frame buffer 820 and used by inter prediction, and the blended pixel value output from the blending circuit 919 is not used by inter prediction involved in generation of the second reconstructed projection-based frame. The blending circuit 919 may be controlled by control information INF_CTRL parsed from the bitstream BS. For example, the control information INF_CTRL may include a flag indicative of chroma sampling position information.

In above embodiments, the blending circuit 123 is a part of the video decoding circuit 122. Alternatively, a blending process may be performed by a different function block implemented in a destination electronic device.

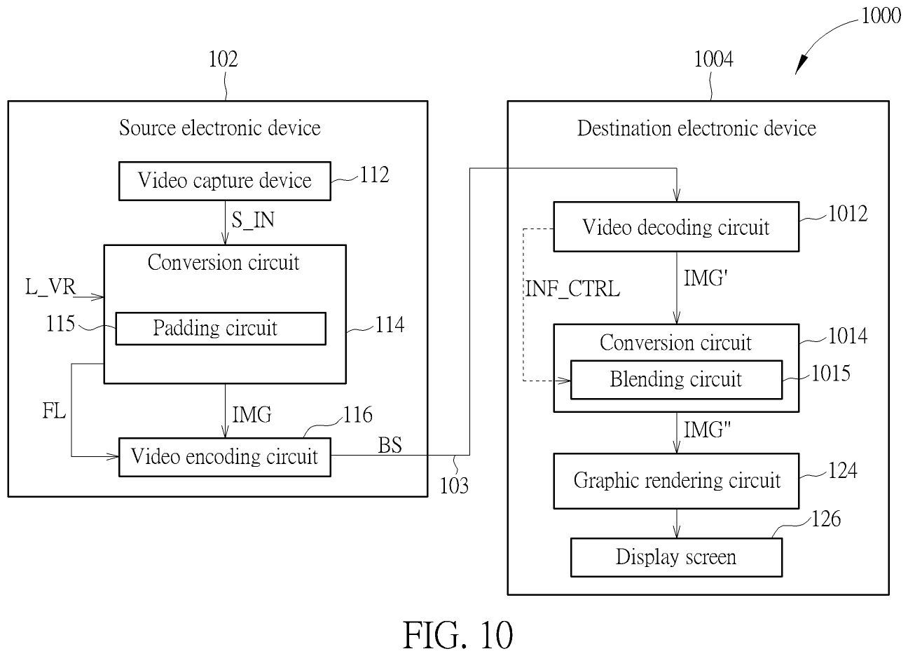

FIG. 10 is a diagram illustrating a second 360 VR system according to an embodiment of the present invention. The major difference between the 360 VR systems 100 and 1000 is that a destination electronic device 1004 has a video decoding circuit 1012 with no blending circuit and a conversion circuit 1014 with a blending circuit 1015. The blending circuit 1015 is used for deriving a target pixel in a target projection layout during a projection format conversion process. The blending circuit 1015 may be controlled by control information INF_CTRL parsed from the bitstream BS. For example, the control information INF_CTRL may include a flag indicative of chroma sampling position information. In this embodiment, the conversion circuit 1014 is implemented in the destination electronic device 1004 to convert a reconstructed frame with a projection layout of a first 360 VR projection format into a converted frame with a projection layout of a second 360 VR projection format that is different from the first 360 VR projection format. For example, the reconstructed projection-based frame (decoded frame) IMG′ generated from the video decoding circuit 1012 may have projection faces and padding regions packed in a cubemap projection layout with padding, and the converted frame IMG″ generated from the conversion circuit 1014 and used by the following graphic rendering circuit 124 may be a projection-based frame with projection faces packed in a typical equirectangular projection (ERP) layout without padding.

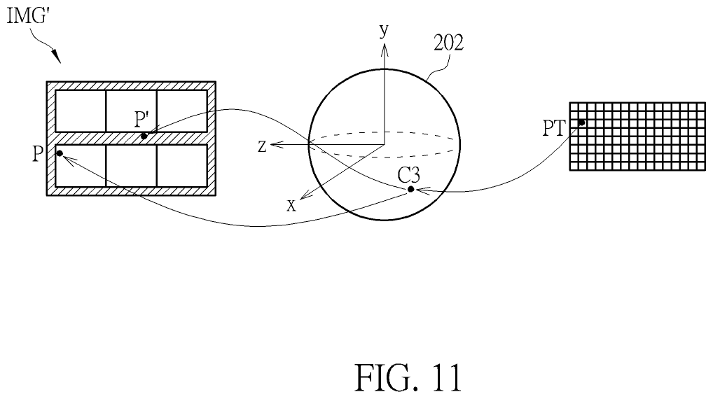

FIG. 11 is a diagram illustrating an example of blending multiple corresponding pixels in a same source frame to derive a target pixel. Suppose that the 360 VR projection layout L_VR is set by the 3×2 cube layout with boundary padding and edge padding 402 as shown in sub-diagram (A) of FIG. 4, and the converted frame IMG″ to be generated from the conversion circuit 1014 is in an ERP layout without padding. Regarding a target pixel PT in the converted frame IMG″, the blending circuit 1015 finds a plurality of corresponding pixels P and P′ in the reconstructed projection-based frame IMG′ generated from the video decoding circuit 1012. The target pixel PT and the corresponding pixels P and P′ are mapped to a same 3D point C3 on the sphere 202, where one corresponding pixel P is located within one projection face of the reconstructed projection-based frame IMG′, and the other corresponding pixel P′ is located within one padding region of the reconstructed projection-based frame IMG′. Specifically, the target pixel PT in the converted frame IMG″ is first mapped to the 3D point C3 on the sphere 202, and then the 3D point C3 on the sphere 202 is mapped to two corresponding pixels P and P′ in the reconstructed projection-based frame IMG′. The blending circuit 1015 generates a blended pixel value by blending pixel values of the corresponding pixels P and P′, and sets a pixel value of the target pixel PT by the blended pixel value.

A pixel located at an integer position (i.e., (x, y), where x and y are integer positions) in the converted frame IMG″ may be mapped to a pixel located at a non-integer position (i.e., (x′, y′), where x′ is not an integer position and/or y′ is not an integer position) in the reconstructed projection-based frame (decoded frame) IMG′. That is, when performing projection layout conversion, the conversion circuit 1015 may set a pixel value of a pixel located at an integer position in the converted frame IMG″ by a blending process that is partly based on a pixel value of a pixel located at a non-integer position in the reconstructed projection-based frame IMG′. Since a pixel value of a pixel located at a non-integer position is not directly available in the reconstructed projection-based frame IMG′, the conversion circuit 1015 may determine the pixel value of the pixel located at the non-integer position in the reconstructed projection-based frame IMG′ by using an interpolation filter (not shown) to process neighboring pixels located at integer positions in the reconstructed projection-based frame IMG′.

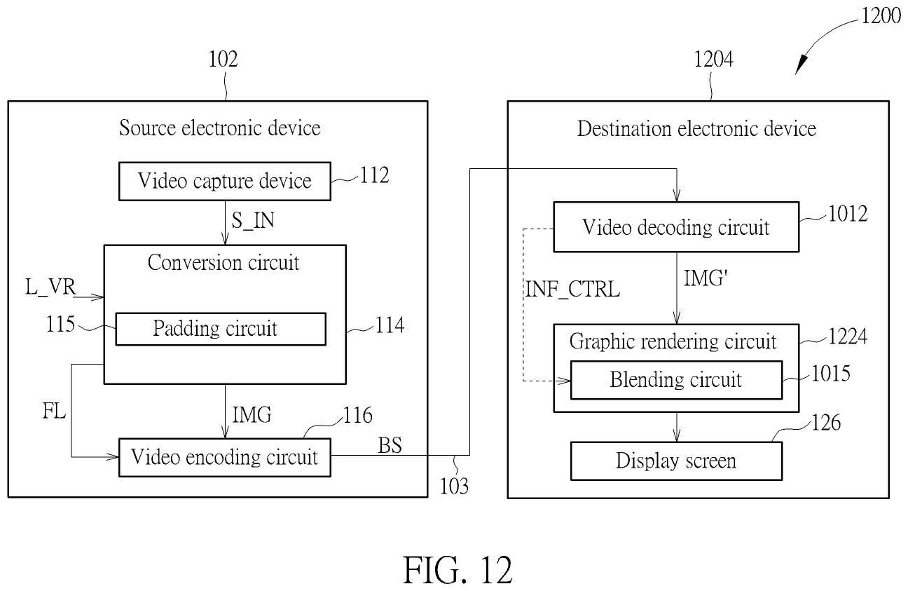

FIG. 12 is a diagram illustrating a third 360 VR system according to an embodiment of the present invention. The major difference between the 360 VR systems 1000 and 1200 is that a destination electronic device 1204 has a graphic rendering circuit 1224 with the blending circuit 1015. In this embodiment, the blending circuit 1015 is used for deriving a target pixel to be displayed on the display screen 126 during a rendering process. The blending circuit 1015 may be controlled by control information INF_CTRL parsed from the bitstream BS. For example, the control information INF_CTRL may include a flag indicative of chroma sampling position information. The image content is presented in the reconstructed projection-based frame (decoded frame) IMG′ according to the 360 VR projection layout L_VR. Since the reconstructed projection-based frame IMG′ has at least one projection face and at least one padding region packed therein, the blending circuit 1015 can be used to derive a target pixel to be displayed on the display screen 126 by blending a corresponding pixel in one projection face and a corresponding pixel in one padding region.

Please refer to FIG. 12 in conjunction with FIG. 11. Suppose that the target pixel PT is a pixel to be displayed on the display screen 126. The blending circuit 1015 finds a plurality of corresponding pixels P and P′ in the reconstructed projection-based frame IMG′ generated from the video decoding circuit 1012. The target pixel PT and the corresponding pixels P, P′ are mapped to a same 3D point C3 on the sphere 202, where one corresponding pixel P is located within one projection face of the reconstructed projection-based frame IMG′, and the other corresponding pixel P′ is located within one padding region of the reconstructed projection-based frame IMG′. Specifically, the target pixel PT to be displayed on the display screen 126 is first mapped to the 3D point C3 on the sphere 202, and then the 3D point C3 on the sphere 202 is mapped to two corresponding pixels P and P′ in the reconstructed projection-based frame IMG′. The blending circuit 1015 generates a blended pixel value by blending pixel values of the corresponding pixels P and P′, and sets a pixel value of the target pixel PT by the blended pixel value.

A pixel located at an integer position (i.e., (x, y), where x and y are integer positions) in the display screen 126 may be mapped to a pixel located at a non-integer position (i.e., (x′, y′), where x′ is not an integer position and/or y′ is not an integer position) in the reconstructed projection-based frame (decoded frame) IMG′. That is, when performing pixel rendering, the conversion circuit 1015 may set a pixel value of a pixel located at an integer position in the display screen 126 by a pixel value of a pixel located at a non-integer position in the reconstructed projection-based frame IMG′. Since a pixel value of a pixel located at a non-integer position is not directly available in the reconstructed projection-based frame IMG′, the conversion circuit 1015 may determine the pixel value of the pixel located at the non-integer position in the reconstructed projection-based frame IMG′ by using an interpolation filter (not shown) to process neighboring pixels located at integer positions in the reconstructed projection-based frame IMG′.

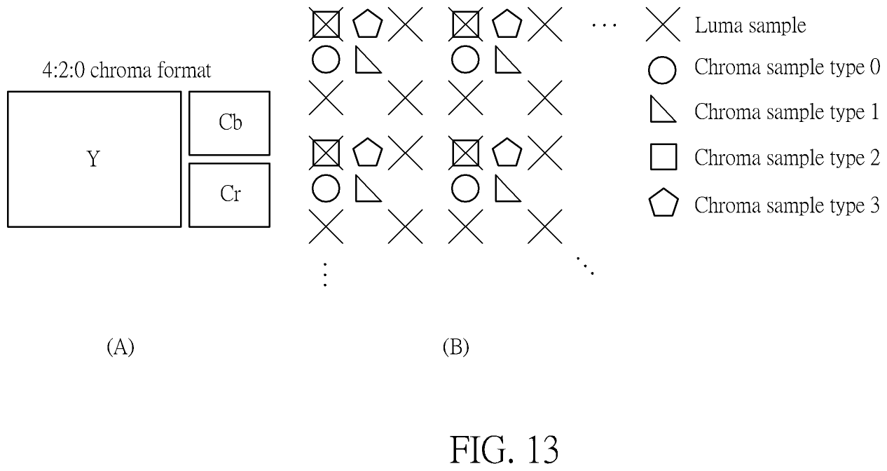

Different chroma formats such as 4:4:4, 4:2:2, and 4:2:0 are commonly used when encoding video sequences. In the 4:2:0 chroma format, the chroma planes (Cb, Cr) are down-sampled by a factor 2 in both horizontal and vertical directions compared to the luma plane (Y), as illustrated in sub-diagram (A) of FIG. 13. The chroma sample location types 0, 1, 2, and 3 indicate the sampling positions of chroma samples with respect to luma samples, as illustrated in sub-diagram (B) of FIG. 13. Different chroma sample location types adopt different sampling positions of chroma samples. When each pixel of a reconstructed projection-based frame to be processed by a blending circuit 123, 819, 919, 1015 consists of one luma sample (Y) and two chroma samples (Cb, Cr) in the YCbCr color space, the present invention proposes informing the blending circuit 123, 819, 919, 1015 of the chroma sampling position information, such that the blending process can generate a blended chroma sample value at a correct chroma sample position. The conversion circuit 114 is further arranged to output a flag FL to the video encoding circuit 116, where the flag FL is indicative of chroma sampling position information (e.g., chroma sample type). The video encoder circuit 116 is further arranged to encode the flag FL into the bitstream BS, such that the flag FL is signaled from the source electronic device 102 to the destination electronic device 104, 1004, 1204 via the bitstream BS. The video decoding circuit 122, 1012 parses the flag FL from the bitstream BS, and sets the control information INF_CTRL of the blending circuit 123, 819, 919, 1015. Specifically, a blending circuit performs a blending process for generating a blended chroma sample value at a target chroma sample position by blending a first chroma sample value obtained for a first chroma sample position in one projection face of a reconstructed projection-based frame and a second chroma sample value obtained for a second chroma sample position in one padding region of the reconstructed projection-based frame, wherein at least one of the target chroma sample position, the first chroma sample position and the second chroma sample position is determined according to the chroma sampling position information that is signaled from a video decoding circuit via a bitstream and parsed from the bitstream at a video decoding circuit.

In a first chroma sampling position signaling design, the chroma sampling position information signaled via the bitstream BS and referenced by the blending process is the flag FL of the blending process. That is, the flag FL encoded into the bitstream BS is particularly set for the decoder-side blending process. Hence, the chroma sampling position in the blending process is explicitly indicated.

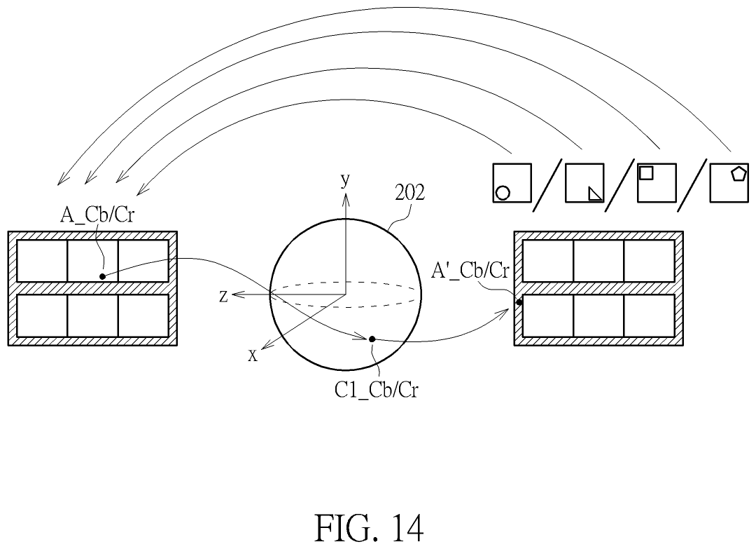

FIG. 14 is a diagram illustrating an example of mapping from a chroma sample in a projection face to its corresponding chroma sample in a padding region. Suppose that the 360 VR projection layout L_VR is set by the 3×2 cube layout with boundary padding and edge padding 402 as shown in sub-diagram (A) of FIG. 4. One chroma sample A_Cb/Cr in a projection face is first mapped to a 3D point C1_Cb/Cr on the sphere 202, where the chroma sample A_Cb/Cr is located at a chroma sample position as explicitly indicated by the flag FL (e.g., chroma sample type) of the blending process that is parsed from a bitstream. Next, the 3D point C1_Cb/Cr on the sphere 202 is mapped to a chroma sample A′_Cb/Cr at a chroma sample position in a padding region through cube-based projection. A chroma sample value of the chroma sample A_Cb/Cr and a chroma sample value of the chroma sample A′_Cb/Cr are blended by, for example, a distance-based weighting function to generate a blended chroma sample value that is used to update the original chroma sample value of the chroma sample A_Cb/Cr.

In a case where the chroma sample A′_Cb/Cr is not directly available in the padding region due to its chroma sample position deviated from a chroma sample position defined by the chroma sample type (which is explicitly indicated by the flag FL). The blending circuit 123, 819, 919 may determine the chroma sample value of the chroma sample A′_Cb/Cr by using an interpolation filter (not shown) to process neighboring chroma samples directly available in the padding region and/or neighboring padding region(s).

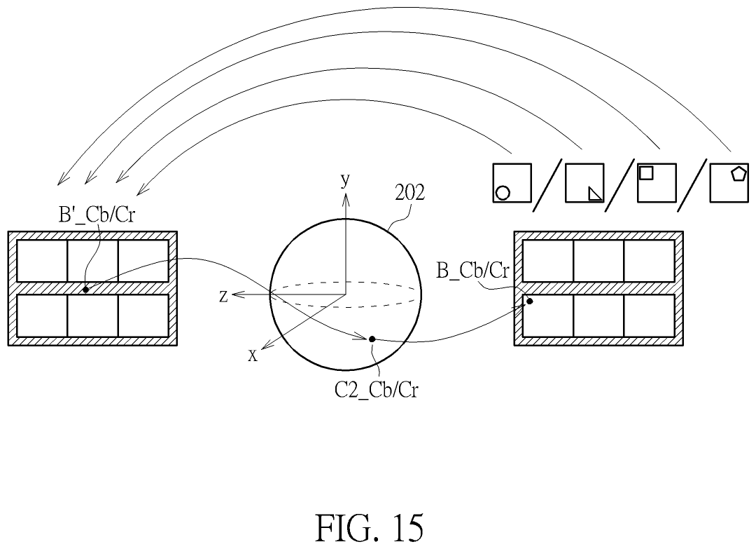

FIG. 15 is a diagram illustrating an example of mapping from a chroma sample in a padding region to its corresponding chroma sample in a projection face. Suppose that the 360 VR projection layout L_VR is set by the 3×2 cube layout with boundary padding and edge padding 402 as shown in sub-diagram (A) of FIG. 4. One chroma sample B′_Cb/Cr in a padding region is first mapped to a 3D point C2_Cb/Cr on the sphere 202, where the chroma sample B′_Cb/Cr is located at a chroma sample position as explicitly indicated by the flag FL (e.g., chroma sample type) of the blending process that is parsed from a bitstream. Next, the 3D point C2_Cb/Cr on the sphere 202 is mapped to a chroma sample B_Cb/Cr in a projection face through cube-based projection. A chroma sample value of the chroma sample B_Cb/Cr and a chroma sample value of the chroma sample B′_Cb/Cr are blended by, for example, a distance-based weighting function to generate a blended chroma sample value that is used to update the original chroma sample value of the chroma sample B′_Cb/Cr.

In a case where the chroma sample B_Cb/Cr is not directly available in the projection face due to its chroma sample position deviated from a chroma sample position defined by the chroma sample type (which is explicitly indicated by the flag FL). The blending circuit 123, 819, 919 may determine the chroma sample value of the chroma sample B_Cb/Cr by using an interpolation filter (not shown) to process neighboring chroma samples directly available in the projection face and/or neighboring padding region(s).

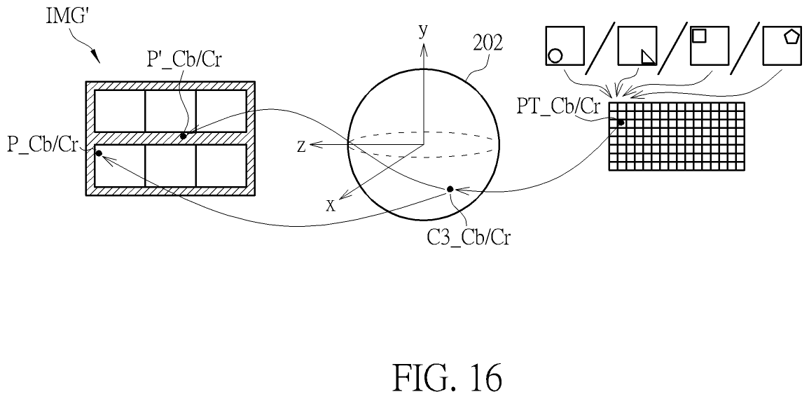

FIG. 16 is a diagram illustrating an example of blending multiple corresponding chroma samples in a same source frame to derive a target chroma sample requested by a rendering process or a projection format conversion process. Suppose that the 360 VR projection layout L_VR is set by the 3×2 cube layout with boundary padding and edge padding 402 as shown in sub-diagram (A) of FIG. 4. Regarding a target chroma sample PT_Cb/Cr in the converted frame IMG″ or the display screen 126, the blending circuit 1015 finds a plurality of corresponding chroma samples P_Cb/Cr and P′_Cb/Cr in the reconstructed projection-based frame IMG′ generated from the video decoding circuit 1012. The target chroma sample PT_Cb/Cr is located at a chroma sample position as explicitly indicated by the flag FL (e.g., chroma sample type) of the blending process that is parsed from a bitstream. The target chroma sample PT_Cb/Cr and the corresponding chroma samples P_Cb/Cr and P′_Cb/Cr are mapped to a same 3D point C3_Cb/Cr on the sphere 202, where one corresponding chroma sample P_Cb/Cr is located within one projection face of the reconstructed projection-based frame IMG′, and the other corresponding chroma sample P′_Cb/Cr is located within one padding region of the reconstructed projection-based frame IMG′. Specifically, the target chroma sample PT_Cb/Cr is first mapped to the 3D point C3_Cb/Cr on the sphere 202, and then the 3D point C3_Cb/Cr on the sphere 202 is mapped to two corresponding chroma sample P_Cb/Cr and P′_Cb/Cr in the reconstructed projection-based frame IMG′. The blending circuit 1015 generates a blended chroma sample value by blending chroma sample values of the corresponding chroma samples P_Cb/Cr and P′_Cb/Cr, and sets a chroma sample value of the target chroma sample PT_Cb/Cr by the blended chroma sample value.

In a case where any of the corresponding chroma samples P_Cb/Cr and P′_Cb/Cr is not directly available in the reconstructed projection-based frame IMG′ due to its chroma sample position deviated from a chroma sample position defined by the chroma sample type (which is explicitly indicated by the flag FL). The blending circuit 1015 may determine the chroma sample value of the corresponding chroma sample P_Cb/Cr (or P′_Cb/Cr) by using an interpolation filter (not shown) to process neighboring chroma samples directly available in the reconstructed projection-based frame IMG′.

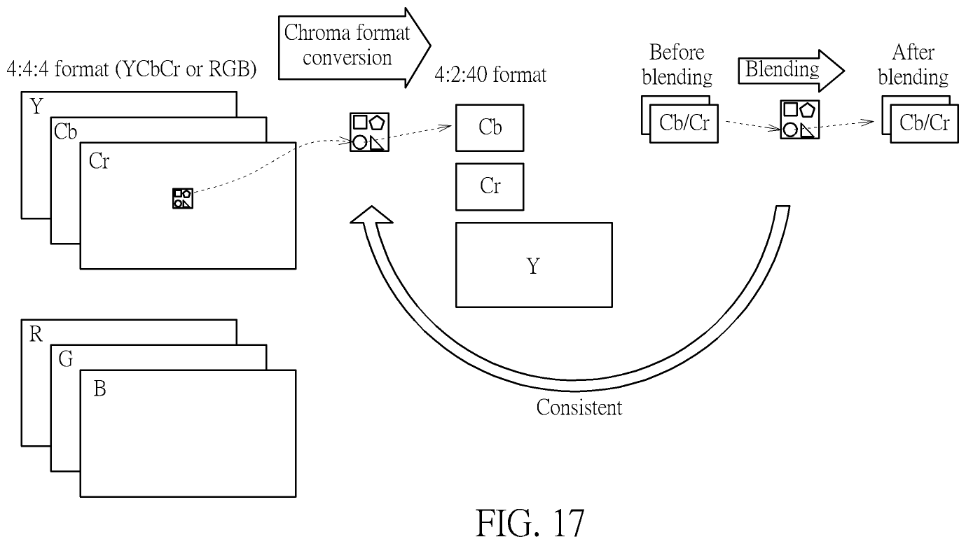

In a second chroma sampling position signaling design, the chroma sampling position information signaled via the bitstream BS and referenced by the blending process is the flag FL of a chroma format conversion process (e.g., 4:4:4 to 4:2:0) performed at the conversion circuit 114. In other words, the chroma sampling position in the decoder-side blending process is consistent with the chroma sampling position in the encoder-side chroma format conversion process. FIG. 17 is a diagram illustrating an example of setting a chroma sampling position in a blending process by a chroma sampling position in a chroma format conversion process. The omnidirectional image/video content S_IN provided by the video capture device 112 may be in a 4:4:4 format (YCbCr or RGB). The conversion circuit 114 may perform a chroma format conversion process upon the omnidirectional image/video content S_IN for providing an omnidirectional image/video content in a 4:2:0 format (YCbCr). Next, the conversion circuit 114 generates the projection-based frame IMG with the 360 VR projection layout L_VR according to an output of the chroma format conversion process. The flag FL is set to indicate the chroma sampling position (e.g., chroma sample type 0) adopted by the chroma format conversion process, and is encoded into the bitstream BS. After the video decoding circuit 122 parses the flag FL of the chroma format conversion process from the bitstream BS, the control information INF_CTRL of the blending circuit 123, 819, 919, 1015 is set by the flag FL, such that the chroma sampling position in the decoder-side blending process is consistent with the chroma sampling position in the encoder-side chroma format conversion process.

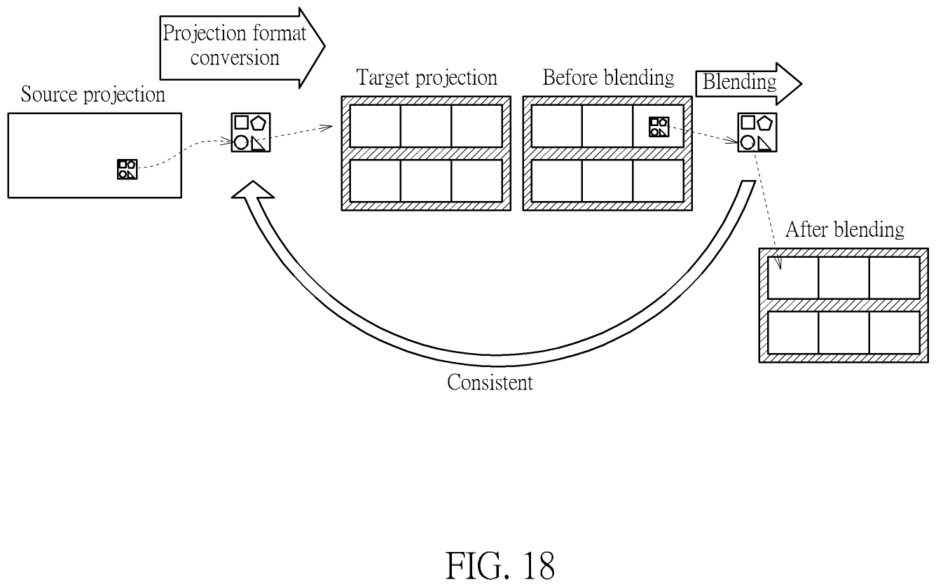

In a third chroma sampling position signaling design, the chroma sampling position information signaled via the bitstream BS and referenced by the blending process is the flag FL of a projection format conversion process performed at the conversion circuit 114. In other words, the chroma sampling position in the decoder-side blending process is consistent with the chroma sampling position in the encoder-side projection format conversion process. FIG. 18 is a diagram illustrating an example of setting a chroma sampling position in a blending process by a chroma sampling position in a projection format conversion process. The omnidirectional image/video content S_IN provided by the video capture device 112 may be arranged in a source projection layout such as an ERP layout. The conversion circuit 114 may perform a projection format conversion process upon the omnidirectional image/video content S_IN for generating the projection-based frame IMG in a target projection layout different from the source projection layout. For example, the target projection layout (i.e., L_VR) may be a cubemap projection layout with boundary padding and edge padding as shown in sub-diagram (A) of FIG. 4. The flag FL is set to indicate the chroma sampling position (e.g., chroma sample type 0) adopted by the projection format conversion process, and is encoded into the bitstream BS. After the video decoding circuit 122 parses the flag FL of the projection format conversion process from the bitstream BS, the control information INF_CTRL of the blending circuit 123, 819, 919, 1015 is set by the flag FL, such that the chroma sampling position in the decoder-side blending process is consistent with the chroma sampling position in the encoder-side projection format conversion process.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A video processing method comprising:
receiving a part of a bitstream;
decoding the part of the bitstream to generate a reconstructed projection-based frame with at least one projection face and at least one padding region packed in a projection layout of a 360-degree Virtual Reality (360 VR) projection;
obtaining chroma sampling position information that is signaled via the bitstream; and
performing, by a blending circuit, a blending process for generating a blended chroma sample value at a target chroma sample position by blending a first chroma sample value obtained for a first chroma sample position in said at least one projection face of the reconstructed projection-based frame and a second chroma sample value obtained for a second chroma sample position in said at least one padding region of the reconstructed projection-based frame, wherein at least one of the target chroma sample position, the first chroma sample position and the second chroma sample position is determined according to the chroma sampling position information.

2. The video processing method of claim 1, wherein the chroma sampling position information signaled via the bitstream and referenced by the blending process is a flag of the blending process.

3. The video processing method of claim 1, wherein the chroma sampling position information signaled via the bitstream and referenced by the blending process is a flag of a chroma format conversion process.

4. The video processing method of claim 1, wherein the chroma sampling position information signaled via the bitstream and referenced by the blending process is a flag of a projection format conversion process.

5. The video processing method of claim 1, wherein the target chroma sample position is identical to the first chroma sample position, and the blending process updates the first chroma sample value by the blended chroma sample value.

6. The video processing method of claim 1, wherein the target chroma sample position is identical to the second chroma sample position, and the blending process updates the second chroma sample value by the blended chroma sample value.

7. The video processing method of claim 1, wherein the target chroma sample position is different from the first chroma sample position and the second chroma sample position.

8. A video processing method comprising:
receiving a bitstream;
decoding one part of the bitstream to generate a first reconstructed projection-based frame with at least one projection face and at least one padding region packed in a projection layout of a 360-degree Virtual Reality (360 VR) projection;
performing, by a blending circuit, a blending process upon the first reconstructed projection-based frame, comprising:
generating a blended pixel value by blending a first pixel value obtained for a first pixel position in said at least one projection face of the first reconstructed projection-based frame and a second pixel value obtained for a second pixel position in said at least one padding region of the first reconstructed projection-based frame; and
decoding another part of the bitstream to generate a second reconstructed projection-based frame, wherein the blended pixel value is used by inter prediction involved in generation of the second reconstructed projection-based frame.

9. A video processing method comprising:
receiving a bitstream;
decoding one part of the bitstream to generate a first reconstructed projection-based frame with at least one projection face and at least one padding region packed in a projection layout of a 360-degree Virtual Reality (360 VR) projection;
performing, by a blending circuit, a blending process upon the first reconstructed projection-based frame, comprising:
generating a blended pixel value by blending a first pixel value obtained for a first pixel position in said at least one projection face of the first reconstructed projection-based frame and a second pixel value obtained for a second pixel position in said at least one padding region of the first reconstructed projection-based frame; and
decoding another part of the bitstream to generate a second reconstructed projection-based frame, wherein the first reconstructed projection-based frame acts as a reference frame used by inter prediction, and the blended pixel value is not used by inter prediction involved in generation of the second reconstructed projection-based frame.

10. A video processing method comprising:
receiving a part of a bitstream;
decoding the part of the bitstream to generate a reconstructed projection-based frame with at least one projection face and at least one padding region packed in a projection layout of a 360-degree Virtual Reality (360 VR) projection;
regarding a target pixel, finding a plurality of corresponding pixels in the reconstructed projection-based frame, wherein the target pixel and the corresponding pixels are mapped to a same point on a sphere, the corresponding pixels comprise a first pixel and a second pixel, the first pixel is located within said at least one projection face of the reconstructed projection-based frame, and the second pixel is located within said at least one padding region of the reconstructed projection-based frame;
generating a blended pixel value by blending pixel values of the corresponding pixels; and
setting a pixel value of the target pixel by the blended pixel value.

11. The video processing method of claim 10, wherein the target pixel is requested by a rendering process.

12. The video processing method of claim 10, wherein the target pixel is requested by a projection format conversion process.
